(19) United States
(12) Patent Application Publication
(10) Pub. No.: US 2016/0004723 A1
(43) Pub. Date: Jan. 7, 2016

(54) Providing Geographically Relevant Information to Users

(71) Applicant: GOOGLE INC., Mountain View, CA (US)

(72) Inventor: Mathew Pretel, Pyrmont (AU)

(21) Appl. No.: 14/321,367

(22) Filed: Jul. 1, 2014

(51) Int. Cl. G06F 17/30

(52) U.S. Cl. CPC G06F 17/30241; G06F 17/30424

(57) ABSTRACT

To provide geographically relevant information to users, a service receives a selection of a geographic area and a selection of one or more topics of interest of interest from a user. Multiple location-specific, time-stamped submissions or posts are received from various users. The submissions are processed to identify one or more recent submissions related to the selected geographic area and relevant to the one or more topics of interest, substantially in real time. The identified recent submissions are provided to a device operated by the user for presentation via a user interface.

### FIELD OF TECHNOLOGY

This disclosure relates to an interactive digital map-based social network and, more specifically, to providing content to users based on geographic areas and topics of interest.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, many social networks allow users to share text, audio, photo, video, and other information. Users can access these social networks through a wide variety of computing devices, including smart phones. A typical social network allows a user to view information submitted by his or her friends, acquaintances, or colleagues.

### SUMMARY

One embodiment of the techniques of this disclosure is a method for providing geographically relevant information to users. The method includes receiving, via one or more computing devices, selections of one or more geographic areas of interest and one or more topics of interest from a user. The method further includes receiving location-specific, time-stamped submissions (or “posts”) from users. The method includes processing these submissions to identify one or more recent submissions relevant to the selected one or more geographic areas and to the one or more topics on interest, substantially in real time. Still further, the method includes providing the identified recent submissions to a device operated by the user for presentation via a user interface.

Another embodiment is a method in a client device for presenting geographically relevant information to a user. The method includes receiving, by one or more processors, a selection of at least one geographic area along with a selection of one or more topics of interest. Further, the method includes providing a request for geographically relevant data to a network server via a communication network, wherein the request includes the selections of the geographic area and the one or more topics of interest. The method then includes receiving, in response to the request, indications of recent submissions determined at the network server to be relevant to the geographic area and the one or more topics of interest. Further, the method includes providing the indications of the recent submissions via a user interface of the client device.

Yet another embodiment is a system including a user database for storing topics and geographic areas on interest to a user profile, a submission database for storing location-specific, time-stamped submissions from a multiplicity of users, and a network server. The network server is configured to select from among the submissions in the submissions database, one or more submissions related to at least one of the geographic areas and related to the one or more topics of interest, substantially in real time. The network server is configured to provide indications of the selected one or more submissions to the user via a communication network.

### BRIEF DESCRIPTION OF THE DRAWINGS

FIG. 1 is a block diagram of an example system in which a service for providing geographically relevant information to users can be implemented;

FIG. 2 is a block diagram of an example client device that can operate in the system of FIG. 1;

FIG. 3 is a block diagram of an example server that can operate in the system of FIG. 1;

FIG. 4 is a flow diagram of an example method for providing geographically relevant information to users; and

FIG. 5 is an example display which the system of FIG. 1 can generate to provide geographically relevant information to users.

### DETAILED DESCRIPTION

### Overview

A geographic notification service of this disclosure allows a user to select one or more areas on an interactive digital map in which the user wishes to “follow” certain topics of interest, as reflected in various submissions by other users. More particularly, the service receives from various participants geo-tagged, time-stamped submissions (or “posts”) that include categorizable content. The participants can be individual users, businesses, organizations, etc. In an example implementation, the service identifies those of the recent posts that are (i) relevant thematically to the one or more topics the user selected (ii) relevant geographically to the one or more geographic areas the user selected, and (iii) relevant temporally to the time at which the user is willing to view posts. The service then alerts the user of the identified posts. Depending on the scenario, the service can alert the user substantially in real time, periodically, in response to the user “checking in,” or according to any other suitable scheme.

In at least some of the embodiments, the geographic notification service receives posts from participating users rather than automatically from websites, for example. In this sense, the geographic notification service in these embodiments is “user-fed.”

Users' posts can be categorized based on content, such as text and images, and/or metadata, such as tags users attach to posts to identify categories. For example, a post can be a text string “Mozart in Ravinia Park tonight,” which the service can parse to automatically categorize the post as probably being relevant to such categories as music, classical music, live music, and Mozart, for example. In another scenario, the user submits a similar text string and manually assigns tags “classical music” and “concert” to the post. Users in some implementation of the service operate certain controls or install certain applications to allow the service to utilize their posts in this manner.

The user who specifies multiple topics of interest to the geographic notification service can specify how combinations of topics of interest should be evaluated. For example, one user can indicate that she is interested only in those posts that match each of the specified topics of interest, while another user can indicate that he is interested in posts that one or more of the specified topics of interest. Further, in some implementations, the user can similarly specify rules with respect to geographic areas and timing.

To determine geographic relevance of a post, the service can determine where the post was originated (e.g., whether the post was submitted in one of the areas of interest), how the post was geo-tagged later, or which geographic locations the post references. Thus, for example, user Alice submits a post from a live concert at Bercy Arena, which her smartphone can automatically tag in accordance with the settings Alice had enabled. User Bob takes a picture at the concert and uploads the picture later than day from home, with an appropriate tag. User Carla, a music critic, posts a comment regarding the concert from yet another location. User Dave has indicated the 12th arrondissement of Paris, where Bercy Arena is located, is one of his areas of interest. Dave also indicated that “live music” is a topic of interest. Depending on the configuration, the service can consider some or all of the types of posts exemplified by submissions from Alice, Bob, and Carla, when selecting relevant posts for Dave. In short, the service can consider geographic relevance of posts based on the place of origination, a geographic tag, the content of the post, or any other indication or a combination of indications of location.

Regarding timing, the service can assess temporal relevance based on the time of submission of the post and/or the time to which the post relates. The service, in some implementations or scenarios, can alert users of relevant posts substantially in real time. A user in these can see new posts, which the service determined to be geographically and thematically relevant, shortly after these posts are submitted. In other cases, the service can determine the time during which geographically and thematically relevant posts also remain temporally relevant. For example, a user can submit a post indicating her band will be playing at a certain bar later the same day. The service may initially notify users who indicated interest in music and in the geographic area in real time, and then continue to provide the post to users while the event remains relevant (in this case, until the end of the day). Thus, a user who activates the service of this disclosure after the relevant has been submitted but before the event mentioned in the post becomes irrelevant, can receive the post upon checking in or shortly thereafter.

Further, the user in some cases can configure the timing parameters for notification. For example, one user may wish to only see posts submitted within the last hour and prefers that the posts be forwarded to her in real time. Another user may prefer to be notified of all relevant events once a day. More generally, the service can implement any notification scheme or combination of notification schemes. Still further, in some scenarios, the system can provide a newsfeed for a selected geographic area, with relevant new posts populating the feed as these posts are received. The posts populating the feed can be relevant to the selected geographic area and/or one or several selected topics of interest.

As discussed below, the service can be implemented in a computing system that includes server-side components to process requests to register areas and topics of interest, select relevant posts, etc. and client-side components to facilitate interaction with the service of this disclosure. For example, a user interface component operating in a client device can provide controls with which a user can draw boundaries on a digital map to demarcate the geographic area of interest. As a more specific example, the user can draw an approximate square around her neighborhood and indicate that she wants to follow family-oriented activities and events during the summer. The user in general can define any number of geographic areas of interest, which may be overlapping or non-overlapping. Further, the areas of interest need not be contiguous, and thus a user can select one area of interest to be in Rio de Janeiro and another area of interest to be in San Francisco, Calif. Similarly, the user interface component can receive a selection of one or more topics of interest as text input, voice input, or any other suitable form of input. The service can provide a pull-down menu or another suitable listing of already-defined topics of interest, or a listing of various tags and keywords known to the service.

Users also can submit posts with selectable levels of precision applied to the location of their posts. For example, a user in one scenario draws a square on a digital map and indicates that her post comes somewhere from within the geographic area enclosed by the square, rather than from her exact current location or from a specific point identified on the digital map. As another example, the user can select a neighborhood on a map and associate the location of the post with the neighborhood. Further, for convenience, the service can allow a user to configure one or several levels of precision for general application to the posts submitted by the user: nearest integer mile marker, nearest landmark, nearest neighborhood, nearest city, etc.

Some implementations of the service further allow users to associate any geographic point with a post. For example, the service can provide an API that associates a specified geographic point with a post irrespective of the current location of the user or his portable device. The service, in at least some of these implementation, requires that the user be properly authorized to invoke the API.

Further, in some implementations, the service can automatically determine topics of interest for a user or generate suggested topics of interest, based on the user's profile. In an example scenario, the service automatically suggests to the user that she follow temporary art exhibitions near her home, based on her previous searches and requests for navigation directions, for example. The user in some of these cases operates certain controls or installs certain applications to allow the service to utilize the user's profile in this manner. If no topics of interest are selected, any post relevant to the geographical area can be appended to the feed.

In addition to posts submitted by various users, the service can provide users with commercial content related to various goods and services. Similar to user posts discussed above, commercial content can be relevant geographically, thematically, and temporally. Commercial content can include, for example, coupons, offers, advertisements, or any type of commercial event announcement. Moreover, the service can analyze newsfeeds and similarly evaluate relevance of the newsfeeds according to location, topics of interest, and time.

The geographic notification service of this disclosure can be implemented in a stand-alone social network, or as a feature of an existing social network, digital mapping application, or another service. For example, the service can operate as part of a geographic service that provides digital maps, navigation instructions, and geospatial search functionality to users. In one such embodiment, the user invokes a mobile geographic application that automatically displays a digital map of an area of interest and overlays geographic markers on the digital map at locations which relevant posts reference. In another embodiment, a client-side component of the service runs as a background task on a user's portable device, receives relevant posts from the server-side component, and provides notifications (such as pop-ups) for the user.

To consider another example scenario, a user from Sydney is on a family holiday in Rio De Janeiro during the Carnival of Brazil. The user may be interested in family-friendly events happening near his hotel. The user may operate the geographic notification software service to select an area on the digital map within a two-mile radius of the hotel and input several topics of interest, such as “family,” “party,” and “Carnival.” The service then selects and provides to the user recent posts related to family-oriented events related to the Carnival, occurring or scheduled to occur near the user's hotel. In another example scenario, the user resides in Sydney but wishes to monitor events related to music events in various geographic areas of interest to her, which can include places remote from Sydney, such as a certain neighborhood in San Francisco and one of the boroughs of New York.

### Example System and Devices

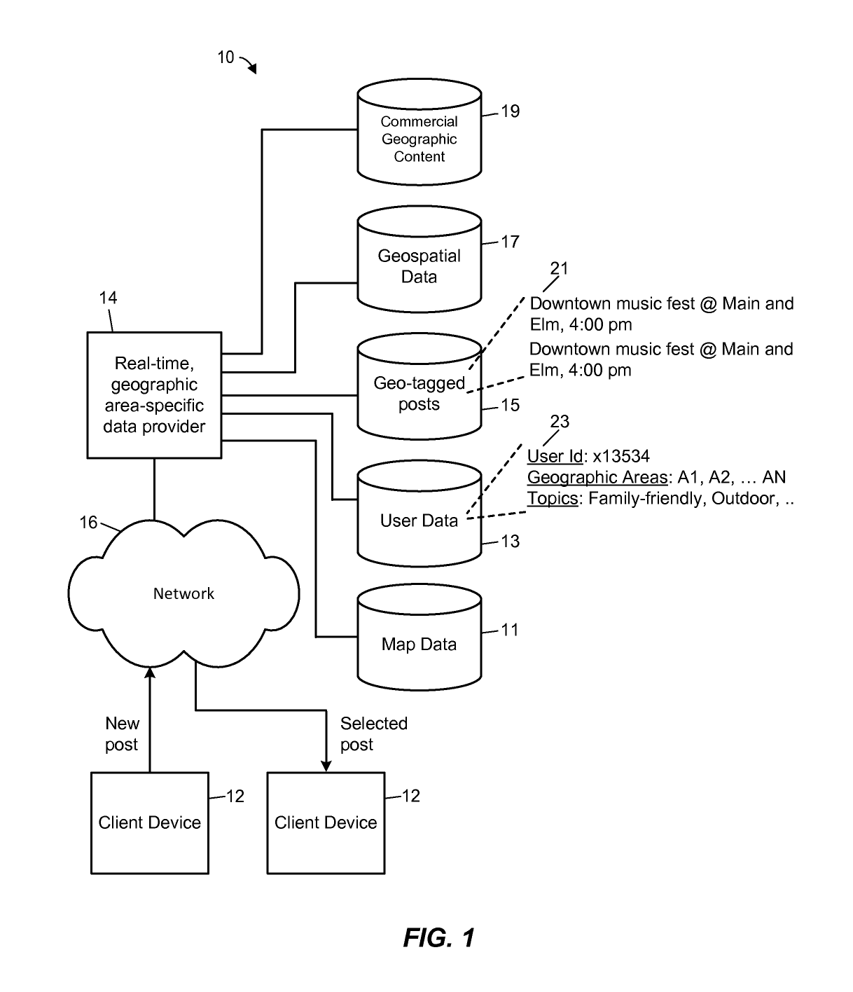

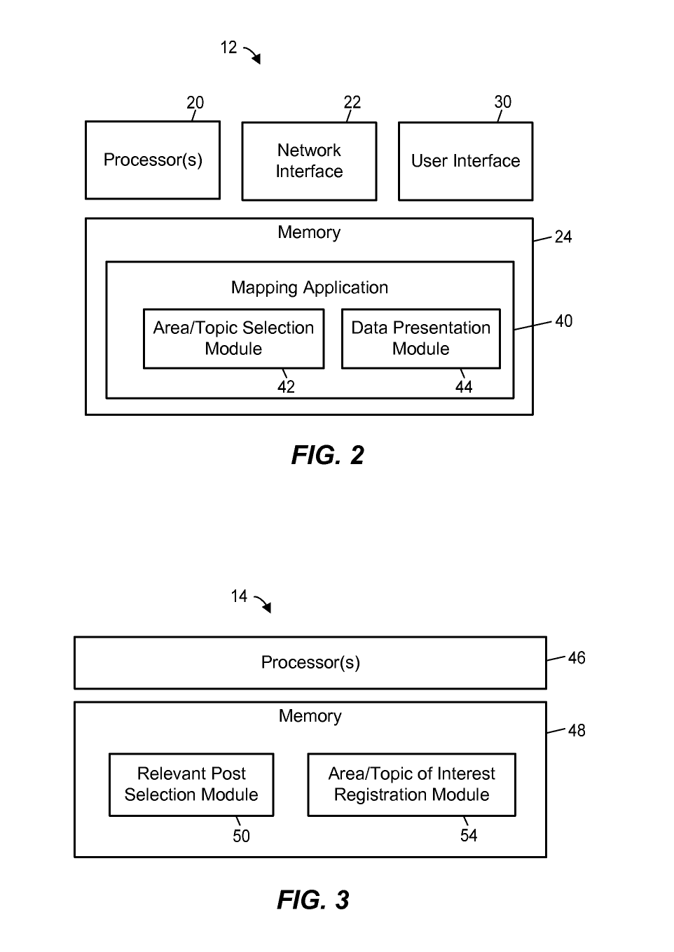

Referring first to FIG. 1, the techniques of this disclosure can be implemented in an example system 10, which includes client devices 12A and 12B coupled to a real-time, geographic area-specific server 14 via a communication network 16. The system 10 is briefly discussed with reference to FIG. 1, followed by a discussion of an example client device and a network server with reference to FIG. 2 and FIG. 3, respectively.

The map server 14 operates as part of an online digital map-based social networking service for providing geographically relevant information on client devices. Each of the computing device 12A or 12B can be a laptop computer, a tablet computer, a smartphone, or another suitable computing device. For example, user Alice can use the client device 12A to submit a post, and user Bob can user the client device 12B to receive a notification of Alice's post, when her post matches Bob's selection of the geographic area and the selected topic(s) of interest.

A map database 11, which may be implemented in the server 14 or separately from the server 11, can store map data for generating digital maps. More specifically, the map database 11 can store information describing locations and dimensions of natural and artificial geographic features such as roads, waterways, parks, landmarks, buildings, etc. The data representation for each place generally includes a set of coordinates (e.g., latitude and longitude) for each vertex and for the center. The data representation for a library, for example, can include a location and a number of attributes, such the physical geometry, the number of stories, height of each story, center coordinates, building type, etc. The map database 11 can store map data in a vector graphics format, a rasterized format, or another suitable format or a combination of formats. In some implementations, map data is divided into “tiles,” or portions of the data of a same fixed size.

The system also can include a user database 13 which can store user-specific information for the online digital map-based social networking service. For example, the user database 13 can store user profile data 23 containing, in part, a user's ID, indices for geographic areas of interest, and indications of topics of interest. The user can operate appropriate user interface controls on the client device 12A or 12B to select one or more geographic areas of interest and topics of interest and cause these selections to be transmitted to the server 14, which in turn can cause these selections to be stored to his or her profile 23.

Further, the system 10 can include a posts database 15 to store geo-tagged, time-stamped posts, including any suitable combinations of text, audio content, photo content, video content, or other content. The geo-tag of a post in the database 15 may correspond to GPS coordinates of the client device at the time or posting, or a location designated by the user by “checking in” or selecting a point on a digital map, for example. The time-stamp of a post can indicate the date and/or time with any desired degree of precision, and in general can be generated at a client device or the server 14. Further, in some implementations and/or scenarios, the post stores an indication of event time in addition to, or instead of, the time-stamp.

Still further, in certain implementations, posts can include privacy parameters set by a user at the time of posting. Privacy parameters can indicate whether a post is to be shared publicly or privately with certain groups or individuals. In some cases, the user can choose to not share posts with anybody at all. A user can specify the desired privacy parameters through a settings toolbar at the time of posting or by including certain tags within the content of the post, for example.

To continue with the example above, Alice can submit, at 12:15 pm, an example post 21 regarding a music festival at the intersection of Main and Elm 4:00 pm. The post 21 can be a publically shared post and include a time-stamp of 12:15 pm as well as indication of the time of the event, 4:00 pm. Depending on the implementation, the server 14 can store the post 21 in a “raw” format as a single text string, or the server 14 can parse the post 21 to generate a data structure including (i) a field that identifies the event, “Downtown music fest,” (ii) an indication of the location of the event, “Main and Elm,” (iii) an indication of the time of the event, “4:00 pm,” And (iv) an indication of a privacy parameter “Public.” In some scenarios, Alice assigns one or more indicators of categories, or tags, to the post 21. Further, in some implementations, the server 14 can parse the post 21 to automatically determine to which topic(s) the content potentially relates, and index the post 21 accordingly. In some embodiments, users submitting posts operate certain controls and/or install certain applications to allow the server 14 to automatically categorize the content of their posts.

When processing posts automatically to identify topics of interest, the server 14 can utilize any number of suitable signals. For example, the server 14 can extract topics of interest text by matching keywords or phrases. In another example, the server 14 can identify hashtags, which can include words or un-spaced phrases prefixed with the number sign (#). In an example scenario, a member of a rescue team filters posts based on hashtag #emmahurricanehelp, and can locate users corresponding to the hashtag by their geographic coordinates. As another example, the server 14 can use image processing techniques to process images relevant to certain topics of interest.

With continued reference to FIG. 1, a geospatial database 17 can store the geometries of user-selected geographic areas of interest. Generally speaking, users can specify areas of interest by selecting simple shapes, such as circles or rectangles, and/or more complex shapes by drawing polylines enclosing irregular polygons, for example. Software executing on the client device 12A or 12B can provide various controls for a user to specify the geographic area of interest. Moreover, in some implementations, the user selects the name of a neighborhood, a city, or a region rather than drawing the boundary of the area of interest on a digital map. The geospatial database 17 can store indications of user-selected areas in any suitable format(s), such as in the form of polylines made up of interconnected sets of geographic coordinates.

Referring still to FIG. 1, a commercial geographic content database 19 can store coupons, advertisements, offers, and other commercial content related to specific geographic locations. Similar to user submissions 21, commercial content can be categorized and geo-tagged.

For simplicity, FIG. 1 illustrates the server 14 as only one instance of a server device. However, the real-time, geographic area-specific data server 14 according to some implementations includes in a group of one or more data server devices, each equipped with one or more processors and capable of operating independently of the other data server devices. Data server devices operating in such a group can process requests from the client device 12A or 12B individually (e.g., based on availability), in a distributed manner where one operation associated with processing a request is performed on one map server device while another operation associated with processing the same request is performed on another server device, or according to any other suitable technique. For the purposes of this discussion, the term “server” may refer to an individual server device or to a group of two or more server devices.

In some embodiments, client device 12A and/or 12B is implemented as a computing device 20 of FIG. 2. The computing device 20 includes processing hardware such as one or more general-purpose processors and/or a graphics processors 21 coupled to a computer-readable memory 24. The computing device 12 also includes a user interface 30, which can include a touchscreen, a screen and a keyboard, a microphone, speakers, etc. The memory 24 is a computer-readable non-transitory storage device that may include both persistent (e.g., a hard disk) and non-persistent (e.g., RAM) memory components. The memory 24 can store instructions of a mapping application 40 executable on the processor(s) 21. The mapping application 40 can include an area/topic selection module 42 which allows a user to select one or more geographic area of interest and topics of interest to “follow.” The mapping application 40 further includes a data presentation module 44, which can display relevant posts. The mapping application 40 in general can include any number of software components.

Depending on the implementation, the mapping application 40 can operate as a separately executable software application, a plugin that extends the functionality of another software application such as a web browser, an application programming interface (API) invokable by a software application, etc. The instructions that make up the mapping application may be compiled and executable on the processor(s) 21 directly or interpreted at runtime, for example. The mapping application 40 may receive map data from the server 14 and use the received map data to generate a digital map. The mapping application 40 also can receive relevant posts from the database 15 and display the posts on the digital map. The area/topic selection module 42 and data presentation module 44 may be provided as an integral part of the mapping application 40 or as a separately installable and downloadable component.

In operation, the area/topic selection module 42 can receive a selection of a geographic area of interest or a topic of interest and generate a description of the corresponding geography. For example, the module 42 can provide a simple drawing tool such as a pencil, and the user can sketch over a digital map to define a boundary of the geographic area of interest. The module 42 also can provide a text input box to receive topics of interests. In some implementations, the module 42 can provide a pull-down menu to receive selections of one or more topics of interest from a list of suggestions. More generally, the module 42 can receive selections of geographic areas and topics of interest in any suitable manner.

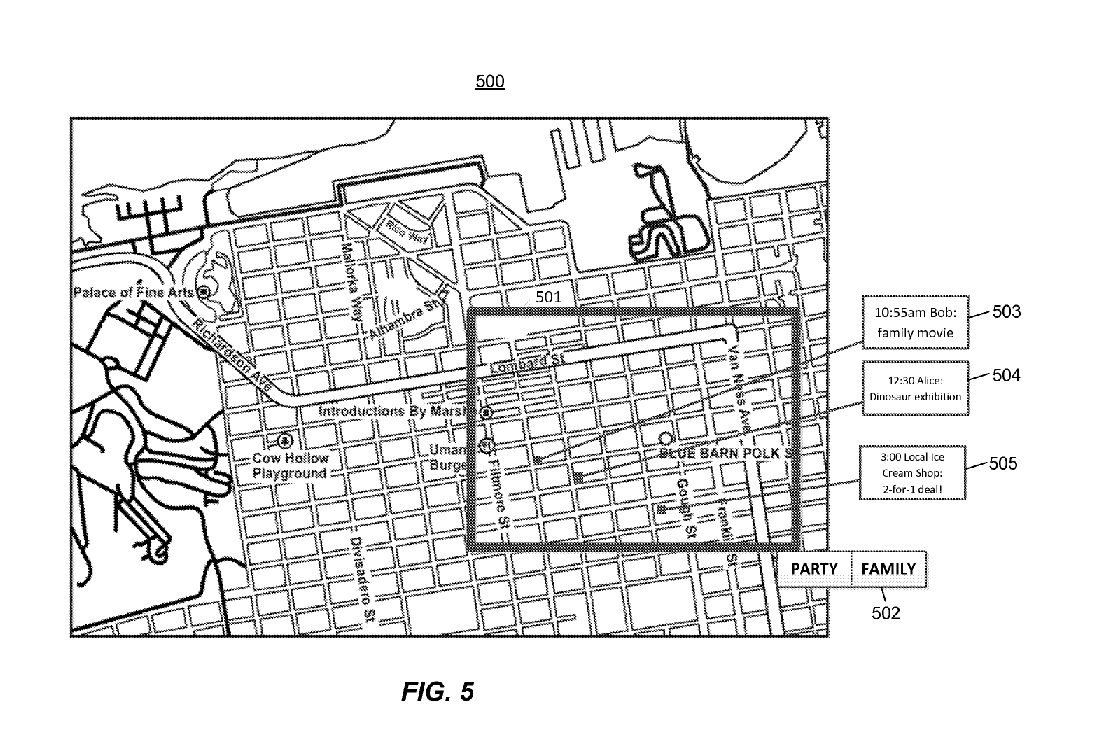

The data presentation module 44 can present relevant posts, received from a network server such as the server 14, in the form of text messages, annotated geographic markers, pop-up windows, or any other user interface element. An example display of relevant posts is discussed further with reference to FIG. 5.

Further, in some implementations, the components 42 and 44 operate in a software application other than a mapping application. For example, the components 42 and 44 can operate in a web browser to receive a selection of a geographic area and present relevant posts to the user, respectively.

Now referring to FIG. 3, the server 14 of FIG. 1 is implemented as a server 100, in an example embodiment. The server 100 can include processing hardware, such as one or more processors 102 coupled to a computer-readable memory 104. The memory 104 can store instructions executable on the one or more processors 102, that implement a relevant post selection module 110 configured to select relevant posts for users and an area of interest registration module 112 configured to process requests from users to register new areas and/or topics of interest.

More specifically, the area of interest registration module 112 can receive data describing a new geographic area and one or more topics of interest from an area/topic selection module 42 or a similar component operating in a client device. This data can include, for example, geographic coordinates of a point and a radius or geographic coordinates of vertices of a polygon enclosing the area of interest. The data also can include a text-based listing of topics of interest pertaining to the geographic area.

The relevant post selection module 110 in this example implementation is configured to receive user profile data. For example, when operating the in the system of FIG. 1, the post selection module 110 can receive potential posts from the database 13 and select those posts that match the geographic area(s) of interest and the topic(s) of interest selected by the user. The post selection module 110 similarly can select relevant commercial content using, for example, database 19. After selecting relevant content, post selection module 110 can provide the selected content to the client device 20 of FIG. 2, for example, where the data presentation module 44 can display the content to a user.

Example techniques which the modules 42, 44, 110, and 112 can implement are discussed in more detail with reference to the remaining figures.

### Example Method for Providing Geographically Relevant Information to Users

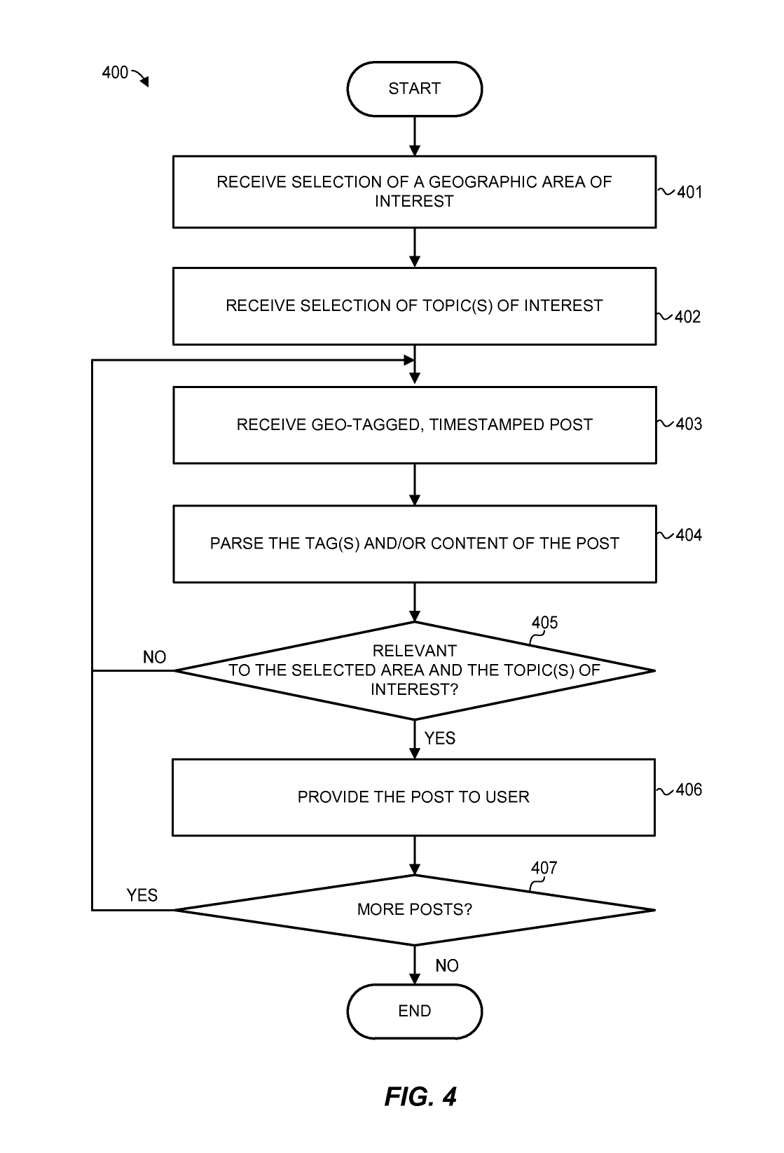

FIG. 4 illustrates a flow diagram of an example method 400 for providing geographically relevant information to users. The method 400 can be implemented in the network server 14, for example, as a set of instructions executable on one or more processors. In general, the method 400 can be implemented in any suitable computing device or group of computing devices.

At block 401, a selection of a geographic area of interest is received. Depending on the implementation, the selection of the geographic area of interest can correspond to a center point and a radius (2 miles, 5 miles, 10 miles, etc.), an indication of a polyline enclosing a polygon, the name of a neighborhood, city, or town, or any other predefined geographic area that corresponds to a shape on the digital map, a geographic area selected and shared by another user, or any other reference to a geographic area. In an example scenario, a user selects the geographic area of interest via the area/topic selection module 42 operating in a client device. The area/topic selection module 42 then forwards the selection to the area/topic of interest registration module 112 operating in a network server. To facilitate selection of a geographic area, the mapping application 40 or module 42 can display an interactive digital map and provide controls for drawing shapes and/or select predetermined shapes (such as circles or rectangles) to demarcate geographic areas of interest. Additionally or alternatively, the module 42 can allow the user to select a location via a click or tap of the user interface, and then specify a radius.

Depending on the implementation, one or multiple areas of interest can be received at block 401. The received selection of the geographic area, or several geographic areas, can be stored in a database. For example, referring back to FIG. 1, the server 14 can store the selection of the geographic area in the database 13.

At block 402, a selection of one or more topics of interest can be received. For example, the area/topic selection module 42 can provide a text box to receive keywords, phrases, names, tags, etc. In general, the user can select topics of interest from a list of available topics or specify his or her own. The selection module 42 can also provide an interactive menu displaying links to currently trending topics for selection. In another implementation, the module 42 may also provide interactive controls to receive audio input.

At blocks 403-407, posts are received and selected for presentation to the user in accordance with the geographic area(s) of interest and topic(s) of the interest selected at block 401 and 402. In particular, a geo-tagged, time-stamped post is received at block 403. As mentioned above, a post can include any combination of text, audio, images, video, and other content. Further, a post can include commercial content such as coupons, advertisements, and offers, as further discussed below.

Each post can be time-stamped based on the time the post is received. Further, a post related to a certain event can indicate the time of the event, which can be used to determine relevance to users' selections in addition to, or instead of, time-stamps. Still further, each post can be geo-tagged according to the location selected by the submitter or according to the location of the device the submitter used. For example, a certain user may post a photo of an event in real time (in this case, as it is taking place), and the geo-tag of the post in this case can correspond to the location where the post was submitted. Another user may post a photo taken with a digital camera from his home computer and manually geo-tag the photograph to indicate the location at which the photo was captured. The geo-tag can be a specific point on a map or a more generalized location such as a neighborhood or city. Users submitting posts can specify levels of geographic precision for their posts individually (for specific posts), generally (for all posts), or based on groups (one level for friends and family, another level for strangers, etc.).

Further, each post can include privacy parameters set by the user at the time of posting. Privacy parameters can indicate whether the post is to be shared publically or privately to certain groups or individuals. A user can set the privacy parameters at the time of posting by selecting certain options from a menu or by including specific tags in the post. Privacy parameters can indicate particular groups such as friends, coworkers, organizations or selected individuals. Further, specific tags can created be implemented so that posts are shared privately within a group. For example, a tag “#NY911” can be used to share posts only with the New York City Police Department. At block 404, the post can be analyzed and categorized using the content of the post and/or metadata attached to the post. For example, the server 14 of FIG. 1 can parse the text portion of a post to detect keywords or various patterns, analyze images, etc. The server 14 also can categorize the post based on tags or other metadata, when available.

The flow continues to block 405, where it is determined whether the post is relevant to the area(s) and topic(s) of interest selected at block 401 and 402. The post generally can be compared to any number of selections of area(s) and topic(s) of interest for any number of users.

For example, the server 14 can search through commercial content database 19 and geo-tagged posts database 15 to find relevant posts and commercial content, using the specified area(s) and topic(s) of interest as keys. Further, the server 14 may determine whether a certain post is relevant based on the time-stamp of the post. Depending on the embodiment, a post may not qualify as relevant after a certain period of time after the post was submitted, or if the time of the event described in the post is not sufficiently close to the time at which block 405 is executed.

As a more specific example, a configurable time interval T can be used to determine whether a certain post qualifies for presentation to a user. In some implementations, the time interval T may depend on the topic(s) of interest: for example, T can be 24 hours for various music or sports events, 48 hours for advertisements, 2 hours for updates regarding other activities or event announcements users may report via posts. Further, the user in some implementations can configure her own time intervals.

In some implementations of the method 400, geographic relevance, thematic relevance, and time relevance are weighed in a certain manner to assess relevance of a post to user's selections. For example, a post can correspond to location just outside the user's area of interest but the tags assigned to the post can closely correspond to the user's topics of interest. The service in some scenarios can assign respective weights to quantitative metrics of geographic, thematic, and temporal matches to determine whether the overall score is sufficiently high, and whether the post should be provided to the user.

With continued reference to FIG. 4, if the post is determined to be generally irrelevant, the flow returns to block 403. On the other hand, if the post is determined to be relevant, the flow proceeds to block 406.

At block 406, the post can be provided to the user. For example, the relevant post selection module 110 can provide the post to the data presentation module 44, which in turn can present the post to a user via user interface 30 (see FIGS. 2 and 3).

The server 14 in some scenarios can notify users of geographically relevant posts substantially in real time, as new posts are submitted. Thus, a user logged into the geographic service of the system 10 can see new geographically and topically relevant posts appear on a digital map being displayed on his smartphone. Further, the server 14 also can check whether posts submitted earlier match the user's area(s) and topic(s) of interest.

At block 407, the method 400 determines whether additional posts are available. If more posts are available, the flow returns to block 403. Otherwise, the method 400 completes.

### Example User Interface

FIG. 5 illustrates an example display 500 which the geographic notification service of this disclosure can provide via a user interface. For example, the data presentation module 44 can present the display 500 via the user interface 30 (see FIG. 2). In the example 500, the geographic notification service in this example has determined that posts 503, 504, and 505 are relevant to the user of the client device. More particularly, both posts 503, 504 and coupon 505 is originated from within, or otherwise relates to, an area of interest 501 and corresponds to each of the topics of interest 502. A geographic marker is provided on the digital map to indicate the location to which a post corresponds, and an off-screen pop-up window is provided with post details.

More generally, any suitable visualization techniques, such as overlay screens, graphic icons, etc. can be used to provide relevant posts to a user. Further, as discussed above, posts can include text, images, videos, and other content.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

For example, the network 16 may include but is not limited to any combination of a LAN, a MAN, a WAN, a mobile, a wired or wireless network, a private network, or a virtual private network. Moreover, while only two clients 12 are illustrated in FIG. 1 to simplify and clarify the description, it is understood that any number of client computers are supported and can be in communication with the server 14.

Additionally, certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmissions (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a time-based geographic marking system for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for providing geographically relevant information to users, through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for providing geographically relevant information to users, the method comprising:
receiving, by one or more computing devices, a selection of a geographic area of interest from a user;
receiving, by the one or more computing devices, a selection of one or more topics of interest from the user;
receiving, by the one or more computing devices, a plurality of location-specific, time-stamped submissions from a multiplicity of users;
processing, by the one or more processors, the plurality of submissions to identify one or more recent submissions related to the selected geographic area and relevant to the one or more topics of interest, substantially in real time; and
providing, by the one or more computing devices, the identified recent submissions to a device operated by the user for presentation via a user interface.

2. The method of claim 1, wherein receiving the selection of the geographic area includes receiving geographic coordinates of a point and a radius.

3. The method of claim 1, wherein receiving the selection of the geographic area includes receiving an indication of a polygon enclosing the geographic area.

4. The method of claim 3, further comprising:
receiving, by the one or more processors, selections of a plurality of geographic areas of interest from the user, including receiving a respective polygon for each of the plurality of geographic areas.

5. The method of claim 1, further comprising:
receiving, by the one or more computing devices, commercial content related to the selected geographic area and the one or more topics of interest, wherein the commercial content includes one or more of (i) a coupon, (ii) an offer, (iii) an advertisement, or (iv) a commercial event announcement, and
providing, by the one or more computing devices, the commercial content to the device operated by the user.

6. The method of claim 1, wherein processing each of the plurality of submissions includes processing one or more tags assigned to the submission by the respective one of the multiplicity of users.

7. A method in a client device for presenting geographically relevant information to a user, the method comprising:
receiving, by one or more processors, a selection of a geographic area;
receiving, by the one or more processors, a selection of one or more topics of interest;
providing, by the one or more processors, a request for geographically relevant data to a network server via a communication network, wherein the request includes the selections of the geographic area and the one or more topics of interest;
in response to the request, receiving indications of recent submissions determined at the network server to be relevant to the geographic area and the one or more topics of interest; and
providing the indications of the recent submissions via a user interface of the client device.

8. The method of claim 7, further comprising:
providing, by the one or more processors, a digital map via the user interface of the client;
wherein receiving the selection of the geographic area includes receiving a selection of a portion of the digital map via the user interface.

9. The method of claim 8, wherein receiving the selection of the portion of the digital map includes receiving a point on the digital map and a radius.

10. The method of claim 8, wherein receiving the receiving the selection of the portion of the digital map includes receiving a description of a polygon drawn over the digital map.

11. The method of claim 7, further comprising:
receiving, by the one or more processors, selections of multiple non-overlapping portions of the digital map via the user interface, wherein the request provided to the network server includes selections of a plurality of geographic areas, each corresponding to a respective one of the multiple non-overlapping portions of the digital map.

12. The method of claim 7, wherein the client device is outside the selected geographic area when the selection of the geographic area is received.

13. The method of claim 7, further comprising:
providing, by the one or more processors via the user interface, a plurality of individually selectable tags used by the users to annotate submissions;
wherein receiving the selection of the one or more topics of interest includes receiving the selection of the one or more of the plurality of tags.

14. The method of claim 7, further comprising:
receiving, by the one or more processors, commercial content determined at the network server to be relevant to the geographic area and the one or more topics of interest.

15. A system configured to provide geographically relevant information to users, the system comprising:
a first database including non-transitory computer-readable medium storing, for a certain user, an indication of one or more topics of interest, and an indication of a plurality of geographic areas of interest, selected by the user;
a second database storing time-stamped, geographic location-specific submissions from a multiplicity of users;
a network server configured to:
select, from among the submissions in the second database, one or more submissions related to at least one of the plurality of geographic areas and related to the one or more topics of interest, substantially in real time, and
provide indications of the selected one or more submissions to the user via a communication network.

16. The system of claim 15, wherein the network server is configured to select the one or more submissions only from among the submissions that originate within, or geo-tagged to, one of the plurality of geographic areas.

17. The system of claim 15, wherein the network server is configured to select the one or more submissions only from among the submissions that were submitted during a certain fixed interval of time.

18. The system of claim 15, wherein the network server is further configured to receive, from the certain user via the communication network, the indication of the plurality of geographic areas of interest and the indications of the one or more topics of interest

19. The system of claim 15, wherein to select the one or more submissions, the network server is configured to process tags assigned to the submissions by the corresponding users.

20. The system of claim 15, wherein to select the one or more submissions, the network server is configured to process content of the submissions.
